(19) United States
(12) Patent Application Publication
(10) Pub. No.: US 2026/0297441 A1
(43) Pub. Date: Oct. 1, 2026

(54) PROCESS FOR THE ONE-STEP HYDROTREATMENT AND HYDROISOMERIZATION OF PLANT OILS USING AT LEAST ONE SULFIDE CATALYST WITH AN ISOMERIZING ZEOLITE

(71) Applicant: IFP ENERGIES NOUVELLES, Rueil-Malmaison (FR)

(72) Inventors: Antoine DAUDIN, Rueil-Malmaison Cedex (FR); Anne-Sophie GAY

(73) Assignee: IFP ENERGIES NOUVELLES, Rueil-Malmaison (FR)

(21) Appl. No.: 19/478,921

(22) PCT Filed: Apr. 23, 2024
(86) PCT No.: PCT/EP2024/061125

§ 371 Date: Oct. 27, 2025

(30) Foreign Application Priority Data
May 12, 2023 (FR) 2304716

(51) Int. Cl. C10G 65/04

(52) U.S. Cl. CPC C10G 65/043; C10G 2300/1014; C10G 2300/1018; C10G 2300/4006; C10G 2300/4012; C10G 2300/4018; C10G 2300/70

(57) ABSTRACT

The present invention describes a process for treating a feedstock derived from a renewable source, comprising a) a step of hydrotreating said feedstock in the presence of at least one fixed-bed catalyst, said catalyst comprising a hydrogenating function and an oxide support, b) a step of hydroisomerizing the entire hydrocarbon-based liquid effluent resulting from step a) in the presence of a difunctional fixed-bed hydroisomerization catalyst, said catalyst comprising a sulfide phase of at least one metal from group VIII in combination with at least one metal from group VIB of the Periodic Table and a support comprising at least one zeolite chosen from IZM-2, ZSM-12 and ZSM-23 zeolites and at least one binder, and c) a step of fractionating the effluent resulting from step b) to obtain at least one gas oil fraction.

### FIELD OF THE INVENTION

The search for new sources of renewable energy for the production of fuels constitutes a major challenge in terms of both meeting demand for fuel and addressing environmental concerns and the decarbonization of the road and air transport sectors.

In this respect, the upgrading of feedstocks from renewable sources into fuels has experienced very strong renewal of interest in recent years. Among these feedstocks, mention may be made, for example, of plant oils such as rapeseed or soybean oils, animal fats, spent cooking oils and also mixtures of such feedstocks. These feedstocks contain chemical structures such as triglycerides, esters or fatty acids. The fatty chains consist of a hydrocarbon-based structure of variable chain length and comprise in general and predominantly from 16 to 18 carbon atoms. Mention may also be made of other types of feedstocks containing fatty acids, such as Tall Oil feedstocks from the paper industry.

One possible route is the catalytic transformation of these feedstocks from renewable sources by hydrotreatment (in the presence of hydrogen) into deoxygenated paraffinic fuel. Many metal or sulfide catalysts are known to be active in this type of reaction. Depending on the length of the hydrocarbon-based chains, the linear paraffins obtained are compatible in terms of boiling points with the hydrocarbons present in fossil gas oil and kerosene fuel bases.

These processes for hydrotreating feedstocks from renewable sources are already well known and are described in numerous patents. Mention may be made, for example, of the following patents: U.S. Pat. Nos. 4,992,605, 5,705,722, EP 1 681 337 and EP 1 741 768.

Transition metal sulfide catalysts allow linear paraffins to be produced by converting oxygenated compounds via two reaction routes:
hydrodeoxygenation (HDO) leading to the formation of water by hydrogen consumption and the formation of hydrocarbons with a carbon number (Cₙ) equal to that of the initial fatty acid chains,
decarboxylation/decarbonylation (DCO) leading to the formation of carbon oxides (carbon monoxide and carbon dioxide: CO and CO₂) and to the formation of hydrocarbons with one carbon less (Cₙ₋₁) relative to the initial fatty acid chains.

This transformation also leads to the formation of byproducts such as propane (from the glycerol structure of the fatty substances) and methane (from the methanation reaction of the carbon oxides under hydrotreatment conditions).

The liquid effluent from these hydrotreatment processes, after gas separation, consists essentially of n-paraffins and is substantially free of sulfur, nitrogen and oxygen impurities. This effluent typically has a sulfur content of between 1 and 20 ppm by weight, a nitrogen content generally of between 0.2 and 30 ppm by weight and an oxygen content generally of less than 2000 ppm by weight. Paraffins typically contain between 9 and 25 carbon atoms, which is mainly dependent on the composition of the fatty acid chain distribution of the renewable feedstock to be hydrotreated.

However, this liquid effluent generally cannot be incorporated into the kerosene or gas oil pool as it is, as it does not directly meet all the specifications of a fuel, for example due to insufficient cold properties and/or boiling temperatures that are too high. Specifically, the linear paraffins present lead to high pour points and therefore to freezing phenomena when used at low temperatures. For example, eicosane (linear paraffin containing 20 carbon atoms, C₂₀H₄₂) has a boiling temperature equal to 340° C. and a melting point of 37° C. The boiling temperature of eicosane is thus compatible with its incorporation into a gas oil pool but its melting point may cause freezing problems and limit its use. By way of illustration, the filterability limit temperature for winter gas oil is a maximum of −15° C. according to French regulations (standard EN590). Moreover, the boiling point of eicosane makes it unsuitable for incorporation into the kerosene pool, for which the final temperature of the D86 distillation curve must be below 300° C. (ASTM standard D1655).

Depending on the type of fuel targeted (kerosene or gas oil) and the targeted fuel specifications, it may be necessary to perform an additional hydroconversion step (hydroisomerization and/or hydrocracking reactions) to transform the linear paraffins in the hydrotreated liquid effluent. Hydroisomerization allows linear paraffins to be converted into branched paraffin with conservation of the number of carbon atoms in the molecule. This allows the cold properties of the effluent to be improved, as branched paraffins have better cold properties and a lower boiling point than the corresponding linear paraffins with the same number of carbon atoms.

For example, nonadecane has a melting point of 32° C. whereas one of its monobranched isomers, 7-methyloctadecane, has a melting point of −16° C. Hydrocracking allows a linear paraffin to be converted into linear or branched paraffins of lower molecular weight. This allows the distillation curve of the effluent to be adjusted as required to make it compatible with the kerosene pool, which has more stringent cold properties and maximum boiling point specifications. By way of illustration, the hydrocracking of an eicosane molecule may lead to the production of two molecules of 2-methylnonane. The boiling temperature of 2-methylnonane is 167° C., which is compatible with incorporation into the kerosene pool in terms of boiling point. The hydroconversion step is performed on a difunctional catalyst having both a hydro/dehydrogenating function and a Brønsted acid function. The operating conditions may be suitable for promoting the hydroisomerization or hydrocracking reactions as required. In all cases, it is desirable to minimize the production of excessively light cracking products that cannot be incorporated into kerosene and gas oil cuts, so as to maximize their yield.

The appropriate choice of acid phase can promote the isomerization of long linear paraffins and minimize cracking. Thus the shape selectivity of zeolites with medium (10 MR) or large (12MR) pores makes their use particularly suitable for obtaining catalysts that are selective towards isomerization and hydroconversion. Other acid phases of the zeolitic or non-zeolitic type, such as halogenated aluminas (notably chlorinated or fluorinated), phosphorus aluminas, silica-aluminas or even silicic aluminas may also be used.

However, it is well known that factors other than the acid phase have an impact on the activity and selectivity of a difunctional catalyst. The hydroisomerization and hydrocracking of normal paraffins have thus been the subject of numerous academic studies since the original work in the 1960s by Weisz (Weisz P., Adv. Catal. 1962, 13, 137) or Coonradt and Garwood (H. L. Coonradt, W. E. Garwood Ind. Eng. Chem. Process Des. Dev. 3 (1) (1964), pages 38-45).

The most commonly accepted mechanism involves n-paraffin first being dehydrogenated to n-olefin at a hydrodehydrogenating site and then, after diffusion to a Brønsted acid site, being protonated to carbenium ion. After structural rearrangement and/or β-scission, the carbenium ions desorb from the acid phase in the form of olefins after deprotonation. Then, after diffusion to a hydrodehydrogenating site, the olefins are hydrogenated to form the final reaction products. It is then necessary to have a hydro/dehydrogenating function which is sufficiently active with respect to the acid function firstly to supply the acid phase rapidly with olefins and secondly to hydrogenate the olefin intermediates rapidly after their reaction with the acid phase. This makes it possible firstly to maximize the activity of the catalyst and secondly to maximize the production of isomerized paraffins by limiting overcracking into light hydrocarbons. The use of a sufficiently active hydrogenating function is also desirable so as to limit the deactivation of the difunctional catalyst by coking during the hydroconversion of n-paraffins (Alvarez et al., Journal of Catalysis, 162, 2, 179-189) for a range of fixed operating conditions.

Noble metals (Pt, Pd) or group VIB transition metals (Mo, W) combined with group VIII transition metals (Ni, Co) may act as the hydro/dehydrogenating function for the catalyst. The noble metals are used in their reduced form, while the transition metals from groups VIB and VIII are used in a sulfurized form.

The choice of the nature of the hydro/dehydrogenating function, of the noble metal or transition metal sulfide type, depends on various criteria, of an economic nature (the price of noble metals is much higher than that of group VIB and VIII transition metals) or of the nature of the charge to be converted (impact of the presence of contaminants). Thus, the hydro/dehydrogenating activity of noble metals is higher than that of transition metal sulfides when the partial pressure of hydrogen sulfide (H₂S) in the reaction medium is low or even zero.

U.S. Pat. No. 8,809,610 (SHELL) claims a process for the production of paraffinic hydrocarbons from a feedstock containing triglycerides, diglycerides, monoglycerides and/or fatty acids. Said process comprises (a) a hydrodeoxygenation step in the presence of hydrogen and a catalyst so as to obtain an effluent comprising water and paraffins, (b) a step of separating the effluent from (a) to obtain a paraffin-rich liquid effluent and (c) a step of hydroisomerizing said paraffin-rich effluent in the presence of hydrogen and a catalyst comprising nickel sulfide and tungsten and/or molybdenum sulfide as hydrogenating phases and a support comprising silica-alumina and/or a zeolite. It is taught that the use of sulfide phases instead of noble metals as hydrogenating phases allows the impurities in the effluent from step (a) not to have to be completely removed.

U.S. Pat. No. 8,039,682 describes a process for producing kerosene from a renewable feedstock, comprising a step of hydrotreating, isomerization and selective hydrocracking in the presence of a multifunctional catalyst or a series of catalysts, a gas/liquid separation step for the effluent obtained, followed by a fractionation step to produce a jet effluent, naphtha and a residual effluent heavier than the jet, and then recycling this residual effluent into the reaction zone with a recycle content relative to the fresh feedstock of between 0.1 and 8. The deoxygenation and hydrogenation function of the catalyst or series of catalysts that may be used in the process according to the invention may be provided by a noble metal such as platinum, palladium, rhodium and ruthenium or by sulfurized metals such as a sulfurized NiMo or sulfurized NiW active phase. The isomerization and selective hydrocracking function may be provided by a zeolite, for instance 10-12MR zeolites such as BEA, MOR, MFI or FAU structure type zeolites, or by an amorphous silica alumina. The patent mentions numerous examples of catalysts that may be used in the process according to the invention: a Pt-based catalyst dispersed on a support comprising a Y zeolite, a catalyst comprising Pt and Pd on a support comprising a Y zeolite and amorphous silica alumina. In another embodiment, a catalyst comprising Pt and/or Pd on a zeolite Y, ZSM-5, amorphous silica alumina, MOR, SAPO-11 and/or SM3 may be used to catalyse all types of reaction. In another embodiment, a catalyst comprising a sulfurized NiMo phase on a zeolite Y, ZSM-5, amorphous silica alumina, MOR, SAPO-11 and/or SM3 may also be used. A series of catalysts may also be a sequence of sulfurized NiMo supported on amorphous silica alumina followed by a Pt-based catalyst supported on amorphous silica alumina. Many other deoxygenation and isomerization and selective hydrocracking catalysts are also mentioned. For example a long list of hydrocracking/isomerization catalysts are mentioned, including a group VIII metal such as Pt and/or Pd, and a support which may be amorphous or crystalline, said support may include aluminas, amorphous silica alumina, and ferrierite-type zeolites, ALPO-31, SAPO-I I, SAPO-31, SAPO-37, SAPO-41, SM-3, MgAPSO-31, FU-9, NU-IO, NU-23, ZSM-12, ZSM-22, ZSM-23, ZSM-35, ZSM-48, ZSM-50, ZSM-57, MeAPO-II, MeAPO-31, MeAPO-41, MeAPSO-11, MeAPSO-31, MeAPSO-41, MeAPSO-46, ELAPO-II, ELAPO-31, ELAPO-41, ELAPSO-I I, ELAPSO-31, ELAPSO-41.

Said patent also teaches that it would be possible to perform the hydroisomerization and hydrocracking step without prior elimination of the water and carbon oxides generated during the hydrotreating step. The example in the patent effectively refers to the sequence of two catalysts without, however, specifying their nature or the presence of zeolite.

This effect is confirmed by Brosius et al. (R. Brosius, P. J. Kooyman, J. C. Q. Fletcher, ACS Catal. 2016, 6, 7710), who studied the hydrocracking reaction of n-hexadecane over a Pt catalyst supported on an MFI-type zeolite, ZSM-5, in the presence of large amounts of water (generated in situ by dehydration of ethanol). It shows that the presence of water greatly reduces the activity of the catalyst, but highlights a beneficial effect on selectivity: the secondary cracking observed on the catalyst using a ZSM-5 zeolite is eliminated, only primary cracking takes place, and also isomerization is reduced, thus favouring the production of linear alkanes. The claimed mode of action is adsorption competition between hydrocarbons and water on hydrophilic acid sites. Thus, that study shows a drastic modification of the activity and selectivity by adding water to the reaction system.

In attempting to develop a process for treating feedstocks from renewable sources to produce middle distillates, the Applicant has demonstrated that a sequence of at least one hydrotreatment step for said feedstock followed by a hydroisomerization step in a single step (i.e. without any intermediate separation of the effluent obtained in the hydrotreatment step) could afford improved activity of said catalyst by using a specific hydroisomerization catalyst comprising a sulfide phase of at least one metal from group VIII in combination with at least one metal from group VIB of the Periodic Table and a support comprising at least one zeolite chosen from IZM-2, ZSM-12 and ZSM-23 zeolites and at least one binder, while at the same time maintaining high yields of middle distillates and preferably of gas oil cut, relative to the use of catalysts conventionally used in the prior art in a one-step process.

The production of high catalytic activity of the hydroisomerization catalyst allows, for example, an increase in the life of the catalyst and a reduction in the frequency with which fresh catalyst has to be replaced.

Another advantage of the present invention is that it provides a process operating in one step comprising a single fractionation zone for the effluent from the hydroisomerization step, which is more economical than a process operating in two steps, while at the same time allowing a high yield of middle distillate cut and preferably of renewable gas oil cut to be obtained.

Another advantage of the process according to the invention is that it allows existing hydrotreatment units to be used without major investment.

For the purposes of the present invention, the various embodiments presented may be used alone or in combination with each other, without any combination limitation.

For the purposes of the present invention, the different parameter ranges for a given step such as pressure ranges and temperature ranges may be used alone or in combination. For example, for the purposes of the present invention, a preferred range of pressure values may be combined with a more preferred range of temperature values.

In the text hereinbelow, the groups of chemical elements are given according to the CAS classification (CRC Handbook of Chemistry and Physics, publisher CRC press, editor D. R. Lide, 81st edition, 2000-2001). For example, group VIII according to the CAS classification corresponds to the metals in columns 8, 9 and 10 according to the new IUPAC classification, and group VIB to the metals in column 6.

In the text hereinbelow, the expressions “of between . . . and . . . ” and “between . . . and . . . ” are equivalent and mean that the limit values of the interval are included in the range of values described. If this were not the case and if the limit values were not included in the range described, such precision will be provided by the present invention.

In the present description, the expression “greater than . . . ” is understood as strictly greater, and symbolized by the sign “>”, and the expression “less than” as strictly less, and symbolized by the sign “<”.

### Aim of the Invention

More specifically, the present invention relates to a process for treating a feedstock from a renewable source comprising at least:
a) a step of hydrotreating said feedstock in the presence of at least one fixed-bed catalyst, said hydrotreating catalyst comprising a hydrogenating function and an oxide support, at a temperature of between 200 and 450° C., at a pressure of between 1 MPa and 10 MPa, at an hourly space velocity of between 0.1 h⁻¹ and 10 h⁻¹ and in the presence of a total amount of hydrogen mixed with the feedstock such that the hydrogen/feedstock ratio is between 70 and 1700 Nm³ of hydrogen/m³ of feedstock,
b) a step of hydroisomerization of the entire hydrocarbon-based liquid effluent from step a) in the presence of a difunctional fixed-bed hydroisomerization catalyst, said catalyst comprising a sulfide phase of at least one metal from group VIII in combination with at least one metal from group VIB of the Periodic Table and a support comprising at least one zeolite chosen from IZM-2, ZSM-12 and ZSM-23 zeolites and at least one binder, said hydroisomerization step being performed at a temperature of between 250° C. and 500° C., at a pressure of between 1 MPa and 10 MPa, at an hourly space velocity of between 0.1 and 10 h⁻¹ and in the presence of a total amount of hydrogen mixed with the feedstock such that the hydrogen/feedstock ratio is between 70 and 1500 Nm³/m³ of feedstock,
c) a step of fractionating the effluent from step b) to obtain at least one gas oil fraction.

In a preferred embodiment, the hydrotreatment step a) and the hydroisomerization step b) are performed in a single step, the process according to the invention not comprising an intermediate separation step between step a) and step b).

### DETAILED DESCRIPTION OF THE INVENTION

### Feedstocks

The present invention is particularly dedicated to the preparation of gas oil fuel bases and optionally kerosene fuel bases corresponding to the new environmental standards, from feedstocks derived from renewable sources.

The feedstocks derived from renewable sources used in the process according to the present invention are advantageously chosen from oils and fats of plant or animal origin, or mixtures of such feedstocks, containing triglycerides and/or free fatty acids and/or esters. The plant oils may advantageously be crude or refined, totally or partially, and derived from the following plants: rapeseed, sunflower, soybean, palm, palm kernel, olive, coconut, jatropha, this list being non-limiting. Seaweed or fish oils are also relevant. Animal fats are advantageously chosen from lard or fats composed of residues from the food or catering industries.

These feedstocks essentially contain triglyceride-type chemical structures which are also known to those skilled in the art as fatty acid triesters, and also free fatty acids. A fatty acid triester is thus composed of three fatty acid chains. These fatty acid chains, in triester or free fatty acid form, have a number of unsaturations per chain, also known as the number of carbon-carbon double bonds per chain, generally between 0 and 3, but which may be higher, notably for oils derived from algae, which generally have a number of unsaturations per chain of 5 to 6.

The molecules present in the feedstocks from renewable sources used in the present invention thus have a number of unsaturations, expressed per triglyceride molecule, advantageously of between 0 and 18. In these feedstocks, the degree of unsaturation, expressed as the number of unsaturations per hydrocarbon-based fatty chain, is advantageously between 0 and 6.

Feedstocks derived from renewable sources generally also include various impurities, notably heteroatoms such as nitrogen. Nitrogen contents in plant oils and animal fats are generally between about 1 ppm and 100 ppm by weight, depending on their nature.

Mention may also be made of other types of feedstocks containing fatty acids, such as Tall Oil feedstocks from the paper industry.

### Process and Catalysts

Advantageously, prior to step a) of the process according to the invention, the feedstock may undergo a pretreatment or pre-refining step so as to remove, via a suitable treatment, contaminants such as metals, like alkaline compounds, for example on ion exchange resins, alkaline-earth metals and phosphorus. Suitable treatments may, for example, be thermal and/or chemical treatments well known to those skilled in the art.

In accordance with step a) of the process according to the invention, the optionally pretreated feedstock is placed in contact with at least one fixed-bed hydrotreating catalyst at a temperature of between 20° and 450° C., preferably between 22° and 350° C., more preferably between 220 and 320° C., and even more preferably between 22° and 310° C. The pressure is between 1 MPa and 10 MPa, preferably between 1 MPa and 6 MPa and even more preferably between 1 MPa and 4 MPa. The hourly space velocity, i.e. the volume of feedstock per volume of catalyst per hour, is between 0.1 h⁻¹ and 10 h⁻¹. The feedstock is placed in contact with the catalyst in the presence of hydrogen. The total amount of hydrogen mixed with the feedstock is such that the hydrogen/feedstock ratio is between 70 and 1700 Nm³ of hydrogen/m³ of feedstock, and preferably between 150 and 1500 Nm³ of hydrogen/m³ of feedstock.

In step a) of the process according to the invention, the fixed-bed hydrotreating catalyst advantageously comprises at least one Group VIII and/or Group VIB metal, taken alone or as a mixture, and a support chosen from the group formed by alumina, silica, silica-alumina, magnesia, clays and mixtures of at least two of these minerals. This support may also advantageously contain other compounds, for example oxides chosen from the group formed by boron oxide, zirconia, titanium oxide and phosphoric anhydride. The preferred support is an alumina support, very preferably η, δ or γ alumina.

Said hydrotreating catalyst is advantageously a catalyst comprising Group VIII metals preferably chosen from nickel and cobalt, taken alone or as a mixture, preferably in combination with at least one Group VIB metal preferably chosen from molybdenum and tungsten, taken alone or as a mixture.

The content of group VIII metal oxides and preferably nickel oxide is advantageously between 0.5% and 10% by weight of nickel oxide (NiO) and preferably between 1% and 5% by weight of nickel oxide, and the content of group VIB metal oxides and preferably molybdenum trioxide is advantageously between 1% and 35% by weight of molybdenum oxide (MoO₃), preferably from 5% to 30% by weight, the percentages being expressed as weight percentages relative to the total mass of the catalyst.

The total content of group VIB and VIII metal oxides in the catalyst used in step a) is advantageously between 5% and 45% by weight and preferably between 6% and 35% by weight relative to the total mass of the catalyst.

Said hydrotreating catalyst used in step a) of the process according to the invention may be chosen so as to orientate the selectivity of the reaction as much as possible towards a hydrogenation conserving the number of carbon atoms in the fatty chains, i.e. the hydrodeoxygenation (HDO) route, so as to maximize the upgrading of the renewable feedstock in fuel cuts and the yield of hydrocarbons entering the distillation range of kerosenes and/or gas oils, and thus limit the loss of carbon in the form of carbon oxides and methane. This is why, preferably, the operation is performed at a relatively low temperature. Maximizing the hydrogenating function also allows polymerization and/or condensation reactions to be limited, leading to the formation of coke which would degrade the stability of the catalytic performance.

Said catalyst used in hydrotreating step a) of the process according to the invention may also advantageously contain a doping element chosen from phosphorus and boron, taken alone or as a mixture, and preferably phosphorus. Said doping element may be introduced into the matrix or preferably deposited on the support. Silicon may also be deposited on the support, alone or with phosphorus and/or boron and/or fluorine.

The oxide content by weight of said doping element is advantageously less than 20%, preferably less than 10%, and advantageously is at least 0.001%.

The metals of the catalysts used in the hydrotreating step a) of the process according to the invention are sulfide metals or metal phases and preferably sulfide metals.

It would not be a departure from the scope of the present invention to use a single catalyst or several identical or different catalysts simultaneously or successively in step a) of the process according to the invention. This step may be performed industrially in one or more reactors with one or more catalytic beds.

Said hydrotreatment step a) allows hydrodeoxygenation, hydrodeazotization and hydrodesulfurization of said feedstock.

In accordance with step b) of the process according to the invention, the entire effluent from step a) of the process according to the invention is converted in the presence of a difunctional fixed-bed hydroisomerization catalyst, said catalyst comprising a sulfide phase of at least one Group VIII metal in combination with at least one metal from Group VIB of the Periodic Table and a support comprising at least one zeolite chosen from IZM-2, ZSM-12 and ZSM-23 zeolites and at least one binder, said hydroisomerization step being performed at a temperature of between 25° and 500° C., at a pressure of between 1 MPa and 10 MPa, at an hourly space velocity of between 0.1 and 10 h⁻¹ and in the presence of a total amount of hydrogen mixed with the feedstock such that the hydrogen/feedstock ratio is between 70 and 1500 Nm³/m³ of feedstock.

Preferably, hydrotreatment step a) and hydroisomerization step b) are performed in a single step, i.e. without any intermediate separation of the effluent from hydrotreatment step a).

The operating conditions of hydroisomerization step b) are adjusted to favour hydroisomerization and/or hydrocracking reactions. Preferably, the hydroisomerization step b) of the process according to the invention operates at a temperature of between 250° C. and 450° C., and very preferably, between 25° and 400° C., at a pressure of between 2 MPa and 10 MPa and very preferably, between 1 MPa and 9 MPa, at an hourly space velocity advantageously of between 0.2 and 7 h⁻¹ and very preferably between 0.5 and 5 h⁻¹, at a hydrogen flow rate such that the hydrogen/feedstock volume ratio is advantageously between 100 and 1000 normal m³ of hydrogen per m³ of feedstock and preferably between 150 and 1000 normal m³ of hydrogen per m³ of feedstock.

In accordance with the invention, the hydroisomerization catalyst is a difunctional catalyst comprising a sulfide phase of at least one Group VIII metal in combination with at least one metal from Group VIB of the Periodic Table and a support comprising at least one zeolite chosen from IZM-2, ZSM-12 and ZSM-23 zeolites and at least one oxide binder.

Said hydroisomerization catalyst is advantageously a catalyst comprising a sulfide phase of at least one Group VIII metal preferably chosen from nickel and cobalt, taken alone or as a mixture, in combination with at least one Group VIB metal preferably chosen from molybdenum and tungsten, taken alone or as a mixture. Preferably, said hydroisomerization catalyst comprises a nickel-molybdenum sulfide phase, a nickel-molybdenum-tungsten sulfide phase or a nickel-tungsten sulfide phase. Preferably, said hydroisomerization catalyst comprises a nickel-tungsten sulfide phase.

The Group VIB metal and preferably tungsten and/or molybdenum content of said catalyst is advantageously, in oxide equivalent, between 5% and 45% by weight relative to the finished catalyst, preferably between 10% and 40% by weight and very preferably between 15% and 35% by weight, and the Group VIII metal and preferably nickel and/or cobalt content of said catalyst is advantageously, in oxide equivalent, between 0.5% and 10% by weight relative to the finished catalyst, preferably between 1% and 8% by weight and very preferably between 1.5% and 6% by weight. According to the invention, said catalyst is used in its sulfide form.

Said catalyst used in hydroconversion step b) of the process according to the invention may also advantageously contain a doping element chosen from phosphorus and boron, taken alone or as a mixture and preferably phosphorus. Said doping element may be introduced into the matrix or preferably deposited on the support. Silicon may also be deposited on the support, alone or with phosphorus and/or boron and/or fluorine.

The oxide content by weight of said doping element is advantageously less than 20%, preferably less than 10%, and advantageously at least 0.001%.

The metals are advantageously placed in the catalyst via any method known to those skilled in the art, for instance co-kneading, dry impregnation, over-impregnation or exchange impregnation.

The hydroisomerization catalyst also advantageously comprises at least one zeolite chosen from IZM-2, ZSM12 and ZSM23 zeolites and at least one oxide binder.

Preferably, the zeolite is chosen from ZSM-12 and ZSM-23 zeolites.

Said binder is advantageously chosen from silica (SiO₂), alumina (Al₂O₃), clays, titanium oxide (TiO₂), boron oxide (B₂O₃) and zirconia (ZrO₂) taken alone or as a mixture. Preferably, said binder is chosen from silica, silica-alumina and alumina, and even more preferably, said binder is alumina in all its forms known to those skilled in the art, such as gamma-alumina, for example.

A preferred hydroisomerization catalyst comprises and preferably consists of a nickel-tungsten sulfide phase and a support comprising and preferably consisting of at least one zeolite chosen from ZSM-12 and ZSM-23 zeolites and at least one alumina binder.

Preferably, said support comprises from 10% to 50% by weight of zeolite, preferably from 12% to 45% by weight, and very preferably between 15% and 40% by weight, relative to the total weight of said support.

Hydrotreatment step a) and hydroisomerization step b) may advantageously be performed in a single reactor or in different reactors, preferably in a single reactor.

In the case where step a) and step b) are performed in a single reactor, one or more catalytic beds comprising at least one hydrotreating catalyst may be used.

Similarly, one or more catalytic beds comprising at least one hydroisomerization catalyst according to the invention may also be used.

The proportion of hydrotreating catalyst in the hydrotreating step a) advantageously represents between 50% and 90% and preferably between 55% and 85% of the total catalyst volume.

The proportion of hydroisomerization catalyst in the hydroisomerization step b) advantageously represents between 10% and 50% and preferably between 15% and 45% of the total catalyst volume.

The term “total catalyst volume” means the sum of the hydrotreating catalyst volume and the hydroisomerization catalyst volume contained in steps a) and b), respectively, whether steps a) and b) are performed in a single reactor or in several reactors.

In accordance with step c) of the process according to the invention, the effluent from step b) undergoes a fractionation step allowing recovery of at least one gas oil fraction.

Preferably, said step c) comprises a gas-liquid separation step followed by a water removal step.

Said step c) may also advantageously comprise an atmospheric distillation step and optionally a vacuum distillation step, to obtain at least one middle distillate fraction.

The purpose of said step c) is to separate the gases from the liquid, to remove water and, notably, to recover hydrogen-rich gases which may also contain light fractions such as the C1-C4 cut and at least one gas oil cut, possibly at least one kerosene cut and possibly at least one naphtha cut.

### EXAMPLES

Examples 1 to 6 describe the preparation of catalysts C1 to C6.

Examples 7 to 11 describe the evaluation in hydrotreating and hydroisomerization of a feedstock from a renewable source of the sequences of the catalyst with C1 with one of the catalysts C2 to C6.

### Example 1: Preparation of a Hydrotreatment Catalyst (C1)

The catalyst is based on nickel, molybdenum and phosphorus on alumina, with contents of molybdenum oxide MoO₃ of 22% by weight, nickel oxide NiO of 4% by weight and phosphorus oxide P₂O₅ of 5% by weight relative to the total weight of the finished supported catalyst on gamma alumina. The forming into shape is performed through a die equipped with orifices 1.85 mm in diameter. This catalyst is obtained by dry impregnation of an aqueous solution comprising metal precursors (molybdenum trioxide and nickel hydroxycarbonate) and orthophosphoric acid. The catalyst then undergoes a calcination step.

### Example 2: Preparation of a Hydroconversion Catalyst (C2) in Accordance with the Invention

To prepare the catalyst support, a mixture of alumina gel and ZSM-12 zeolite is formed into shape by kneading-extrusion through a die equipped with quadrilobal orifices 1.5 mm in diameter, dried at 80° C. and calcined at 550° C. The ZSM12 content in the support is 19% by weight.

The support extrudates are then subjected to a dry impregnation step with an aqueous solution of ammonium metatungstate and nickel nitrate, left to mature in a water maturator for 24 hours at room temperature, dried at 120° C. for 5 hours and then calcined for two hours under dry air in a through-bed at 450° C. (temperature rise ramp of 5° C./min). The tungsten oxide WO₃ content by weight of the finished catalyst after calcination is 28%, the nickel oxide NiO content is 3.6%.

### Example 3: Preparation of a Hydroconversion Catalyst (C3) in Accordance with the Invention

To prepare the catalyst support, a mixture of alumina gel and ZSM-23 zeolite is formed into shape by kneading-extrusion through a die fitted with quadrilobal orifices 1.85 mm in diameter and calcined at 550° C. The ZSM23 content in the support is 40% by weight.

The support extrudates are then subjected to a dry impregnation step with an aqueous solution of molybdenum trioxide, nickel hydroxycarbonate and phosphoric acid, left to mature in a water maturator for 24 hours at room temperature and dried at 120° C. for 5 hours. The molybdenum oxide MoO₃ content by weight of the finished catalyst after drying is 24%, the nickel oxide NiO content is 4.7% and the phosphorus P₂O₅ content is 5.7%.

### Example 4: Preparation of a Hydroconversion Catalyst (C4) Outside the Invention

Silica-alumina powder is prepared according to the synthetic protocol described in patent EP1 415 712A. The amounts of orthosilicic acid and aluminium hydrate are chosen so as to have a composition of 70% by weight of alumina Al₂O₃ and 30% by weight of silica SiO₂ in the final solid.

This mixture is rapidly homogenized in a commercial colloid mill in the presence of nitric acid, so that the nitric acid content of the suspension leaving the mill is 8% relative to the mixed silica-alumina solid. The suspension is then conventionally spray-dried from 300° C. to 60° C. The powder thus prepared is kneaded in a Z-arm in the presence of 8% nitric acid relative to the anhydrous product. Extrusion is then performed by passing the dough through a die fitted with quadrilobal orifices 1.4 mm in diameter. The extrudates thus obtained are oven-dried at 140° C., then calcined under a dry air flow rate at 550° C. and then calcined at 850° C. in the presence of water vapour.

The support extrudates are then subjected to a dry impregnation step with an aqueous solution of ammonium metatungstate and nickel nitrate, left to mature in a water maturator for 24 hours at room temperature, dried at 120° C. for 5 hours and then calcined for two hours under dry air in a through-bed at 450° C. (temperature rise ramp of 5° C./min). The tungsten oxide WO₃ weight content of the finished catalyst after calcination is 27%, the nickel oxide NiO content is 3.9%.

### Example 5: Preparation of a Hydroconversion Catalyst (C5) Outside the Invention

To prepare the catalyst support, a mixture of alumina gel and zeolite USY (with an Si/Al ratio of 15 at/at and a mesh size of 24.28 Å) is formed into shape by kneading-extrusion, through a die fitted with trilobal orifices 2 mm in diameter, dried at 80° C. and then calcined at 550° C. The USY content in the support is 17.5% by weight.

The support extrudates are then subjected to a dry impregnation step with an aqueous solution of molybdenum oxide, nickel hydroxycarbonate and phosphoric acid, left to mature in a water maturator for 24 hours at room temperature and dried at 120° C. for 5 hours. The molybdenum oxide MoO₃ content by weight of the finished catalyst after drying is 19%, the nickel oxide NiO content is 3.7% and the phosphorus P₂O₅ content is 4.5%.

### Example 6: Preparation of a Hydroconversion Catalyst (C6) in Accordance with the Invention

To prepare the catalyst support, a mixture of alumina gel and ZSM-23 zeolite is formed into shape by kneading-extrusion through a die fitted with 1.5 mm-diameter quadrilobal orifices and calcined at 550° C. The ZSM23 content in the support is 18% by weight.

The support extrudates are then subjected to a dry impregnation step with an aqueous solution of molybdenum trioxide, nickel hydroxycarbonate and phosphoric acid, left to mature in a water maturator for 24 hours at room temperature and dried at 120° C. for 5 hours. The molybdenum oxide MoO₃ content by weight of the finished catalyst after drying is 24%, the nickel oxide NiO content is 4.7% and the phosphorus P₂O₅ content is 5.7%.

### Examples 7 to 11: Evaluation in Hydrotreatment and Hydroconversion of a Feedstock from a Renewable Source According to a Process in Accordance with the Invention of the Sequences of Catalyst C1 with Catalysts C2 to C6

In a fixed-bed reactor, temperature-controlled in the manner required for isothermal operation, the feedstock is 60% by volume of hydrotreatment catalyst C1 and 40% by volume of hydroconversion catalyst. The catalyst C1 is placed at the reactor inlet and the hydroconversion catalyst at the second position (reactor outlet). With the catalysts pre-sulfurized, hydrotreatment and hydroconversion are performed on pre-refined rapeseed oil with a density of 920 kg/m³ and an oxygen content of 11% by weight. The fatty acid distribution of the rapeseed oil is detailed in Table 1. Prior to the hydrotreatment step, said feedstock is supplemented with dimethyl disulfide so as to adjust its sulfur content to 50 ppm by weight.

TABLE 1
Table 1: Characteristics of the rapeseed oil
used as feedstock for the hydrotreatment

| Fatty acid | |
|---|---|
| composition | (%) |
| 14:0 | 0.1 |
| 16:0 | 5.0 |
| 16:1 | 0.3 |
| 17:0 | 0.1 |
| 17:1 | 0.1 |
| 18:0 | 1.5 |
| 18:1 trans | <0.1 |
| 18:1 cis | 60.1 |
| 18:2 trans | <0.1 |
| 18:2 cis | 20.4 |
| 18:3 trans | <0.1 |
| 18:3 cis | 9.6 |
| 20:0 | 0.5 |
| 20:1 | 1.2 |
| 22:0 | 0.3 |
| 22:1 | 0.2 |
| 24:0 | 0.1 |
| 24:1 | 0.2 |

Prior to hydrotreating the feedstock, the catalysts are sulfurized in-situ in the unit, with isane supplemented with 2% by weight of dimethyl disulfide, at a total pressure of 7 MPa, and a hydrogen/supplemented gas oil ratio of 1000 Nm³/m³. The sulfurizing feedstock volume per catalyst volume per hour is set at 0.41. Sulfurization is performed for 12 hours at 350° C., with a temperature rise ramp of 10° C. per hour.

After sulfurization, the operating conditions of the unit are adjusted so as to perform hydrotreatment and hydroconversion of the feedstock:
HSV (feedstock volume/total catalyst volume/hour): 0.41 h⁻¹
total working pressure: 7 MPa,
hydrogen/feedstock ratio: 1000 Nm³ hydrogen/m³ feedstock.

The hydrogen used is supplied by Air Products and has a purity of over 99.999% by volume.

Temperature steady stages at 340 to 355° C. are performed so as to vary the severity of the hydroconversion.

At the unit outlet, an on-line gas chromatography analysis and a gas meter allow calculation of the mass of light hydrocarbons produced and present in the hydrogen stream.

The liquid effluent is accumulated for 12 hours. Said liquid effluent is then weighed and analysed by simulated distillation (ASTM D2887) to determine the middle distillate yield (“120° C.+ cut”, corresponding to the hydrocarbons present in the gas and liquid fraction with a boiling temperature of more than 120° C.).

The middle distillate yield is calculated as follows:

Yield (middle distillate)=[(mass liquid effluent*% cut 120° C.+/100+ mass [C8-C13] gas)/(mass liquid effluent+ mass light hydrocarbons (gas)+ mass water+ mass COx)] *100

The mass of liquid effluent corresponds to the mass of liquid recipe accumulated over 12 hours.

The % cut 120° C.+ is obtained by simulated distillation: mass fraction of liquid effluent with a boiling point above 120° C.

The mass [C8-C13] gas is obtained by on-line gas chromatographic analysis of the hydrogen stream at the unit outlet. It corresponds to the mass of hydrocarbon-based compounds containing between 8 and 13 carbon atoms.

The mass of water is the sum of the mass of settled water present in the liquid effluent and the mass of water present in the gases, analysed on-line by gas chromatography.

The COx mass is the mass of carbon oxides (CO and CO₂) present in the gas phase, and is determined by on-line analysis using gas chromatography.

Moreover, the cloud point is determined by the method ASTM D5773.

According to Example 7 (in accordance with the invention), the first zone is charged with catalyst C1 (60% by volume), and then the second with catalyst C2 (40% by volume).

According to Example 8 (in accordance with the invention), the first zone is charged with catalyst C1 (60% by volume), and then the second with catalyst C3 (40% by volume).

According to Example 9 (not in accordance with the invention), the first zone is charged with catalyst C1 (60% by volume), and then the second with catalyst C4 (40% by volume).

According to Example 10 (not in accordance with the invention), the first zone is charged with catalyst C1 (60% by volume), and then the second with catalyst C5 (40% by volume).

According to Example 11 (in accordance with the invention), the first zone is charged with catalyst C1 (60% by volume), and then the second with catalyst C6 (40% by volume).

Catalyst C4 is defined as a reference. The performance criteria are as follows:
Conversion activity expressed by the temperature increase relative to the reference required to reach a cloud point of −7° C. in the liquid effluent. A negative value indicates a gain in activity.
Average distillate yields obtained for a liquid effluent cloud point of −7° C. It is expressed as a deviation relative to the reference. A negative value indicates a loss of yield.

The main characteristics of the effluents produced and the associated operating conditions are listed in Table 3.

TABLE 2
Table 2: Main characteristics of the effluents produced
by hydrotreatment and hydroisomerization

| | | Zeolite | | Difference |
|---|---|---|---|---|
| | | content | Temper- | in yield of |
| | | in the | ature | middle |
| | | hydroiso- | difference | distillate |
| | | merization | (° C.) for a | at a cloud |
| | Hydro- | catalyst | cloud | point of |
| | isomerization | support | point of | −7° C. |
| Example | catalyst | (wt %) | −7° C. | (wt %) |
| Example 7 | C2-NiW/ | 19% | −34 | −7 |
| (compliant) | ZSM-12 | | | |
| Example 8 | C3-NiMoP/ | 40% | −26 | −5 |
| (compliant) | ZSM-23 | | | |
| Example 9 | C4-NiW/SiAl | | BASE | BASE |
| (non-compliant) | | | | |
| Example 10 | C5-NiMoP/ | 17.5% | −45 | −39 |
| (non-compliant) | USY | | | |
| Example 11 | C6-NiMoP/ | 18% | −23 | +2 |
| (compliant) | ZSM-23 | | | |

The compliant catalyst C2 allows the production of a gas oil cut with a gain in conversion activity of 34° C. relative to the base case, while at the same time maintaining a high middle distillate yield.

The compliant catalyst C3 allows the production of a gas oil cut with a gain in conversion activity of 26° C. relative to the base case, while at the same time maintaining a high yield of middle distillate.

The non-compliant catalyst C5 allows the production of a gas oil cut with a high gain in conversion activity of 45° C. relative to the base case, but the yield of middle distillate is considerably degraded.

The compliant catalyst C6 allows production of a gas oil cut with a gain in conversion activity of 23° C. relative to the base case, while at the same time maintaining a high yield of middle distillate.

1. A process for treating a feedstock derived from a renewable source, comprising at least the following steps:
a) a step of hydrotreating said feedstock in the presence of at least one fixed-bed catalyst, said hydrotreating catalyst comprising a hydrogenating function and an oxide support, at a temperature of between 200 and 450° C., at a pressure of between 1 MPa and 10 MPa, at an hourly space velocity of between 0.1 h⁻¹ and 10 h⁻¹ and in the presence of a total amount of hydrogen mixed with the feedstock such that the hydrogen/feedstock ratio is between 70 and 1700 Nm³ of hydrogen/m³ of feedstock,
b) a step of hydroisomerization of the entire hydrocarbon-based liquid effluent resulting from step a) in the presence of a difunctional fixed-bed hydroisomerization catalyst, said catalyst comprising a sulfide phase of at least one metal from group VIII in combination with at least one metal from group VIB of the Periodic Table and a support comprising at least one zeolite chosen from IZM-2, ZSM-12 and ZSM-23 zeolites and at least one binder, said hydroisomerization step being performed at a temperature of between 250° C. and 500° C., at a pressure of between 1 MPa and 10 MPa, at an hourly space velocity of between 0.1 and 10 h⁻¹ and in the presence of a total amount of hydrogen mixed with the feedstock such that the hydrogen/feedstock ratio is between 70 and 1500 Nm³/m³ of feedstock,
c) a step of fractionation of the effluent resulting from step b) to obtain at least one gas oil fraction.

2. The process according to claim 1, in which the feedstock derived from renewable sources is chosen from oils and fats of plant or animal origin, or mixtures of such feedstocks, containing triglycerides and/or free fatty acids and/or esters.

3. The process according to claim 1, in which, in step a), the feedstock is placed in contact with a fixed-bed catalyst at a temperature of between 22° and 350° C., at a pressure of between 1 MPa and 6 MPa, and at an hourly space velocity of between 0.1 h⁻¹ and 10 h⁻¹. The feedstock is placed in contact with the catalyst in the presence of hydrogen and in the presence of a total amount of hydrogen mixed with the feedstock such that the hydrogen/feedstock ratio is between 150 and 750 Nm³ of hydrogen/m³ of feedstock.

4. The process according to claim 1, in which the fixed-bed hydrotreating catalyst used in step a) advantageously comprises at least one Group VIII and/or Group VIB metal, taken alone or as a mixture, and a support chosen from the group formed by alumina, silica, silica-aluminas, magnesia, clays and mixtures of at least two of these minerals.

5. The process according to claim 1, in which the hydroisomerization step b) operates at a temperature of between 250° C. and 450° C., at a pressure of between 2 MPa and 10 MPa, at an hourly space velocity of between 0.2 and 7 h⁻¹, and at a hydrogen flow rate such that the hydrogen/feedstock volume ratio is between 100 and 1000 normal m³ of hydrogen per m³ of feedstock.

6. The process according to claim 1, in which said hydroisomerization catalyst comprises a sulfide phase of at least one Group VIII metal, taken alone or as a mixture, in combination with at least one Group VIB metal, taken alone or as a mixture.

7. The process according to claim 6, in which said hydroisomerization catalyst comprises a nickel-molybdenum sulfide phase, a nickel-molybdenum-tungsten sulfide phase or a nickel-tungsten sulfide phase.

8. The process according to claim 7, in which said hydroisomerization catalyst comprises a nickel-tungsten sulfide phase.

9. The process according to claim 1, in which the zeolite is chosen from the zeolites ZSM-12 and ZSM-23.

10. The process according to claim 1, in which the hydrotreatment step a) and the hydroisomerization step b) are performed in a single step.

11. The process according to claim 10, in which the process according to the invention does not comprise an intermediate separation step between step a) and step b).

12. The process according to claim 5, wherein the hydroisomerization step b) operates at a temperature of between 25° and 400° C.

13. The process according to claim 5, wherein the hydroisomerization step b) operates at a pressure of between 1 MPa and 9 MPa.

14. The process according to claim 5, wherein the hydroisomerization step b) operates at an hourly space velocity of between 0.5 and 5 h⁻¹.

15. The process according to claim 5, wherein the hydroisomerization step b) operates at a hydrogen flow rate such that the hydrogen/feedstock volume ratio is between 150 and 1000 normal m³ of hydrogen per m³ of feedstock.

16. The process according to claim 1, wherein said hydroisomerization catalyst comprises a sulfide phase of at least one Group VIII metal selected from nickel and cobalt, taken alone or as a mixture, in combination with at least one Group VIB metal selected from molybdenum and tungsten, taken alone or as a mixture.
